(19) United States
(12) Patent Application Publication
(10) Pub. No.: US 2010/0035524 A1
(43) Pub. Date: Feb. 11, 2010

(54) METHOD OF PRODUCING OPTICAL ELEMENT, AND OPTICAL ELEMENT

(75) Inventors: Masashi Hanaoka, Nagano (JP); Kenichi Hayashi, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 11/916,147

(22) PCT Filed: Jun. 1, 2006
(86) PCT No.: PCT/JP2006/310971

§ 371 Date: Oct. 28, 2009

(30) Foreign Application Priority Data
Jun. 6, 2005 (JP) JP2005-165979
Jun. 6, 2005 (JP) JP2005-165980

(51) Int. Cl. B23C 3/16; B24B 13/00; B29C 33/38; G02B 3/00

(52) U.S. Cl. 451/42; 409/166; 409/183; 451/277

(57) ABSTRACT

While having a milling cutter, equipped with a rotary shaft and a blade portion projecting in the direction intersecting with the axial line direction of the rotary shaft, rotated about the axial line of said rotary shaft, the milling cutter and the base material for forming an optical device are relatively moved in the cutting-in direction and the feed direction to form machining faces that constitute the device face. At the boundary part of the machining faces, the rotary shaft is directed in the direction orthogonal to the boundary part to cut the lower machining face of two adjacent machining faces.

The objective is to provide a method for manufacturing an optical device in which a step can be formed at the boundary part between two adjacent machining faces when manufacturing an optical device or a mold by cutting, and to provide an optical device.

### CROSS REFERENCE TO RELATED APPLICATIONS

This is a U.S. national stage of application No. PCT/JP2006/310971, filed on 1 Jun. 2006. Priority under 35 U.S.C. §119(a) and 35 U.S.C. §365(b) is claimed from Japanese Application No. 2005-165979, filed 6 Jun. 2005, and Japanese Application No. 2005-165980, filed 6 Jun. 2005, the disclosures of both of which are also incorporated herein by reference.

### TECHNICAL FIELD

The present invention relates to a method for manufacturing an optical device by cutting or grinding an optical material that constitutes an optical device or a base material for forming an optical device such as a mold material that constitutes a mold for molding an optical device.

### TECHNICAL BACKGROUND

An ultra precision machining by a milling cutter has been applied to machining of an optical material that constitutes an optical device or a mold material that constitutes a mold for molding an optical device. (See Patent reference 1, for example).

In such an ultra precision machining by a milling cutter, as shown in FIG. 14, a milling cutter 10, equipped with a blade portion 12 projecting from a rotary shaft 11 in the direction intersecting with the axial line direction, is used as a cutting tool; while having the rotary shaft 11 rotated about the axial line, the cutting tool and a base material 20 are relatively moved in the cutting-in direction and the feed direction which are the directions intersecting with the axial line direction to form a machining face 21.

Normally, such machining is controlled by NC data (number control data) represented by the Cartesian coordinate system; with an NC machine tool or a machining center, the relative position between the tool and the base material, such as the cutting-in direction and feed direction of the tool, is controlled based on NC data.

Patent reference 1: Patent Application 2004-219494 Publication

### PROBLEMS TO BE SOLVED

However, in recent years there has been need for the use of an optical device in which multiple device faces are arranged in the radial direction. For machining such device faces of an optical device by using NC data represented by the Cartesian coordinate system as in a conventional manner, efficiency in creating NC program is low. Also, the feed direction of the tool is frequently changed; consequently, the tool has to travel a long distance, degrading machining efficiency.

Also, in recent years there has been demand for an optical device in which the boundary part 22 between two adjacent machining faces 21 is formed as a step as shown in FIG. 15 (a). When such an optical device is manufactured by a milling cutter, as shown in FIG. 15 (b) as an enlargement of the area enclosed by a circle, A, in FIG. 15 (a), the step at the boundary part 22 between the machining faces 21 results in a shape with roundness that the blade edge of the milling cutter 10 creates with the rotation radius, that is, results in having a blunt corner. For example, the rotation radius of a general milling cutter 10 is set to several mm to obtain several 10 μm for the height of the step; therefore, there will be an error (roundness of internal edge) of several 100 μm at the step. Such an error (roundness of internal edge) is not a serious problem to normal mechanical components; however, it is not preferable for optical devices because light incident on the boundary part 22 will be lost. This problem is not limited to cutting by a milling cutter, but occurs in the same manner to machining by other tools such as a grinding tool in which a disk-like or cylindrical grindstone projects from the rotary shaft as a blade portion.

Considering the above problems, the present invention may provide a method for manufacturing an optical device which can efficiently machine a plurality of machining surfaces arranged radially, and to provide an optical device.

The present invention may also provide a method for manufacturing an optical device which can form a step with no blunt corners at the boundary part between adjacent machining faces, and to provide an optical device.

To achieve the above, at least one embodiment method for manufacturing an optical device of the present invention provides that, for forming a predetermined machining face by cutting, grinding or polishing a base material used for manufacturing an optical device with a tool, the relative position between the tool and the base material be controlled by the conditions represented by the cylindrical polar coordinate system.

Thus, the relative position between the tool and the base material is controlled by the conditions represented by the cylindrical polar coordinate system. In other words, the Cartesian coordinate system (X, Y, Z) is controlled by the cylindrical polar coordinate system (Rw, θw, Yw) having the following relations:

Rw=√(X²+Z²)

θw=arctan(Z/X)

Yw=Y

Therefore, when the machining faces are arranged in multiple in the circumferential direction, if the feed direction of the tool is set in the radial direction, for example, the operation of feeding the tool in a straight line may be simply repeated. Also, if the feed direction of the tool is set to an arc shape, the operation of feeding the tool along the line of an arc shape, having a given position as a center, may be simply repeated. Thus, according to the present invention, the same feeding operation is simply repeated; therefore, programming for machining is done more easily than with the Cartesian coordinate system. Also, the moving direction of the tool does not need to be changed frequently; therefore, the travel distance of the tool can be shortened. Accordingly, the multiple machining faces arranged in the radial direction can be efficiently machined.

In at least an embodiment of the present invention, when the machining faces are arranged in multiple in the circumferential direction, it is preferred that, for forming the multiple machining faces, the feed direction be set in the radial direction from a given position on the base material. In this way, the center area is machined multiple times, and therefore, it will be finished to a surface with little surface roughness; this area in an optical device is near the optical axis; therefore, the optical property of the optical device can be improved.

Also, in this embodiment, when the machining faces are arranged in multiple in the circumferential direction, for forming the multiple machining faces, the feed direction may be set to trace an arc shape, having a given position on the base material as a center. In this way, the width of the machining path is even and the machining resistance is constant; therefore, the machining face can be finished to a surface that has little deviation in shape.

Thus, at least an embodiment of the present invention may be applied to machining in which the relative position between the tool and the base material is continuously changed in the cutting-in direction to machine the machining face to be a curved surface.

In at least an embodiment of the present invention, the tool is a milling cutter, end mill, cutting tool or grindstone, for example. The tool can be a square milling cutter, square end mill or square cutting tool, whose blade shape is rectangular when the blade portion is viewed from its rake face, or a grindstone whose edge portion is angular. Also, the tool may be a convex radius milling cutter, ball end mill or convex radius cutting tool, whose blade shape is circular when the blade portion is viewed from its rake face, or a grindstone whose edge portion is in an arc shape.

In at least an embodiment of the present invention, when a milling cutter, equipped with a rotary shaft and a blade portion projecting in the direction intersecting with the axial line direction of the rotary shaft, is used as the tool, it is preferred that, while having the milling cutter rotated about the axial line of the rotary shaft, the milling cutter and the base material be relatively moved in the cutting-in direction and the feed direction to form the machining face, and for creating a step at the boundary part between adjacent machining faces, the rotary shaft of the milling cutter be directed in the direction orthogonal to the boundary part to cut the lower machining face of the two adjacent machining faces. In this manner, for machining a machining face, the tool and the base material are relatively moved to cut the base material; for forming the boundary part, the rotary shaft of the tool is directed in the direction orthogonal to the boundary part. Therefore, the shape of the boundary part can be controlled by the shape of the blade portion with high precision, and the step can be shaped such that the side face wall stands upright. For this reason, for an optical device, a step can be formed so that light incident on the boundary area will be prevented from being lost or going astray. When a square milling cutter having a rectangular blade edge or a grinding tool in the same shape is used, the smaller the width of the edge is, the less light loss will be; when a convex radius milling cutter having a circular blade edge or a grinding tool in the same shape is used, the smaller the edge, R, is, the less light loss will be. The width of the blade edge of the tool having a rectangular edge is preferably 20 μm or less, and more preferably 10 μm or less. When the tool having a circular edge is used, the edge, R, is preferably 0.2 mm or less, and more preferably 0.1 mm or less.

In at least an embodiment of the present invention, when a single-blade end mill, equipped with a rotary shaft and a blade portion projecting from an end face of the rotary shaft, is used as the tool, it is preferred that, while having the end mill rotated about the axial line of the rotary shaft, the end mill and the base material be relatively moved in the cutting-in direction and the feed direction to form the machining face, and it is also preferred that, for creating a step at the boundary part between adjacent machining faces, the rotary shaft be raised to machine the lower machining face of the two adjacent machining faces.

In at least an embodiment of the present invention, when a grindstone, equipped with a rotary shaft and a grindstone projecting in the direction intersecting with the axial line of the rotary shaft, is used as the tool, it is preferred that, while having the grindstone rotated about the axial line of the rotary shaft, the grindstone and the base material are relatively moved in the cutting-in direction and the feed direction to form the machining face; it is also preferred that, for forming a step at the boundary part between adjacent machining faces, the rotary shaft be directed in the direction orthogonal to the boundary part to grind the lower machining face of the two adjacent machining faces. Also, in the present invention, when a grindstone with shaft, equipped with a rotary shaft and a grindstone projecting from an end face of the rotary shaft, is used as the tool, it is preferred that, while having the grindstone with shaft rotated about the axial line of the rotary shaft, the grindstone with shaft and the base material be relatively moved in the cutting-in direction and the feed direction to form the machining face; it is also preferred that, for forming a step at the boundary part between adjacent machining faces, the rotary shaft be raised to grind the lower machining face of the two adjacent machining faces. Further, when a wheel-type grindstone that will be attached to a rotary disk is used as the tool, it is preferred that, while having the grindstone turned with the rotary disk, the grindstone and the base material be relatively moved in the cutting-in direction and the feed direction to form the machining face; it is also preferred that, for creating a step at the boundary part between adjacent machining faces, a main spindle of the rotary disk be directed in the direction orthogonal to the boundary part to grind the lower machining face of the two adjacent machining faces.

In the present invention, when a cutting tool is used as the tool, it is preferred that the cutting tool be relatively moved with respect to the base material in the cutting-in direction and the feed direction to form the machining face; it is also preferred that, for forming a step at the boundary part between adjacent machining faces, the cutting tool be raised to cut the lower machining face of the two adjacent machining faces.

In at least an embodiment of the present invention, the base material is an optical material that constitutes the optical device or a mold material for molding the optical device.

Also, at least an embodiment of the present invention provides that, in a method for manufacturing an optical device in which a step is formed at the boundary part between adjacent device faces, while having a tool that has a rotary shaft and a blade portion projecting from the rotary shaft toward the side rotated about the axial line of the rotary shaft, the tool and a base material for forming an optical device are relatively moved in the cutting-in direction and the feed direction to form a machining face; for creating a step at the boundary part between adjacent machining faces, the rotary shaft is directed in the direction orthogonal to the boundary part to cut or grind the lower machining face of the two adjacent machining faces.

In at least an embodiment of the present invention, for machining a machining face, the tool and the base material are relatively moved to cut or grind the base material; for forming the boundary part, the rotary shaft of the tool is directed in the direction orthogonal to the boundary part. Therefore, the shape of the boundary part can be controlled by the shape of the blade portion with high precision, and the step can be shaped such that the side face wall stands upright. For this reason, for an optical device, the step can be formed so that light incident on the border area will be prevented from being lost or going astray.

In at least an embodiment of the present invention, the tool is a milling cutter. In this case, the milling cutter is a square milling cutter whose blade edge is rectangular when the blade portion is viewed in the feed direction. In this way, the boundary part can be machined by a straight side face of the blade portion; therefore, the side face wall of the step can be machined nearly perpendicular. Also, in at least an embodiment of the present invention, the milling cutter may be a convex radius milling cutter whose blade edge is circular when the blade portion is viewed in the feed direction.

At least an embodiment of the present invention can be applied to machining that uses a grinding tool as the tool, in which a disk-like or cylindrical grindstone projects as the blade portion from the rotary shaft.

At least an embodiment of the present invention can be applied to machining in which the relative position between the tool and the base material is continuously changed in the aforementioned cutting-in direction to machine the machining face to be a curved surface.

In at least an embodiment of the present invention, when the machining faces are arranged in multiple in the circumferential direction, it is preferred that, for forming the multiple machining faces, the feed direction be set in the radial direction from a given position on the base material. In this way, for cutting the machining face, the rotary shaft is directed in the direction intersecting with the boundary part; for cutting the vicinity of the boundary part, the rotary shaft is directed in the direction orthogonal to the boundary part and the feed direction is parallel to the boundary part. Therefore, the shape of the boundary part can be controlled by the shape of the blade portion with high precision. Also, the center area is cut multiple times and therefore, can be finished to a smooth surface. In an optical device, such an area is near the optical axis; thus, the optical property of the optical device can be improved.

In at least an embodiment of the present invention, the machining faces are arranged in multiple in the circumferential direction; for machining the multiple machining faces, the feed direction may be set to trace an arc shape that has a given position on the base material as a center.

In at least an embodiment of the present invention, it is preferred that machining by the afore-mentioned tool be controlled by the conditions represented by the cylindrical polar coordinate system. In this way, programming for machining is done more easily than with the Cartesian coordinate system.

In at least an embodiment of the present invention, the base material is an optical material that constitutes the optical device, or a mold material for molding the optical device. However, when high precision is required for the shape of the step, it is preferred that the optical material that constitutes the optical device be cut as the base material to manufacture the optical device.

### EFFECTS OF THE INVENTION

In at least an embodiment of the present invention, the relative position between the tool and the base material is controlled by the conditions represented by the cylindrical polar coordinate system; therefore, when the machining faces are arranged in multiple in the circumferential direction, the feed direction of the tool is set in the radial direction, for example, so that the tool is simply fed on a straight line repeatedly. Also, when the feed direction of the tool is set to trace an arc shape, the operation of feeding the tool along the arc having a given position as its center is simply repeated. Thus, according to at least an embodiment of the present invention, the same operation is simply repeated; therefore, programming for machining is easier than conventional machining with the Cartesian coordinate system; also there is no need to frequently change the moving direction of the tool; therefore, the travel distance of the tool can be shortened. Therefore, multiple machining faces arranged in the radial direction can be efficiently machined.

Further, in at least an embodiment of the present invention, for machining the machining face, the tool and the base material are relatively moved to cut the base material; for forming the boundary part, the rotary shaft of the tool is directed in the direction orthogonal to the boundary part. Therefore, the boundary part can be highly precisely shaped by using the shape of the blade portion, and the step can be shaped such that the side face wall stands upright. In this manner, for an optical device, a step can be formed so that light incident on the border area is prevented from being lost or going astray. When a square milling cutter having a rectangular edge or a grinding tool of the same shape is used, the narrower the width of the blade edge is, the less light loss will be; when a convex radius milling cutter having a circular edge or a grinding tool of the same shape is used, the smaller the blade edge, R, is, the less light loss will be. The width of the rectangular blade edge of the tool is preferably 20 μm or less, and more preferably 10 μm or less. When the tool having a circular edge is used, the edge, R, is preferably 0.2 mm or less and more preferably 0.1 mm or less.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1 (a) and (b) are respectively an explanatory illustration of an optical device to which the present invention may be applied, and a cross-sectional view of a step formed at a border area between machining faces (device faces) of the optical device.

FIG. 2 An explanatory illustration of a square milling cutter.

FIG. 3 An explanatory illustration showing a machining method (a method for manufacturing an optical device) of Embodiment 1 of the present invention.

FIG. 4 An explanatory illustration of the cylindrical polar coordinate system.

FIG. 5 An explanatory illustration showing machining of the boundary part in the machining method shown in FIG. 3.

FIG. 6 A cross-sectional view of the machining by the method shown in FIG. 5.

FIG. 7 An explanatory illustration showing a machining method (a method for manufacturing an optical device) of Embodiment 2 of the present invention.

FIG. 8 An explanatory illustration showing the tilted rotary shaft in the machining method shown in FIG. 7.

FIG. 9 An explanatory illustration showing a machining method (a method for manufacturing an optical device) of Embodiment 3 of the present invention.

FIG. 10 An explanatory illustration showing a machining method (a method for manufacturing an optical device) of Embodiment 4 of the present invention.

FIGS. 11a and 11b Are explanatory illustrations of another optical device in which a border area of the machining faces is formed as a step.

FIG. 12 An explanatory illustration of another square milling cutter.

FIG. 13 An explanatory illustration of a method for manufacturing an optical device of the present invention, in which a grinding tool with shaft is used as the tool.

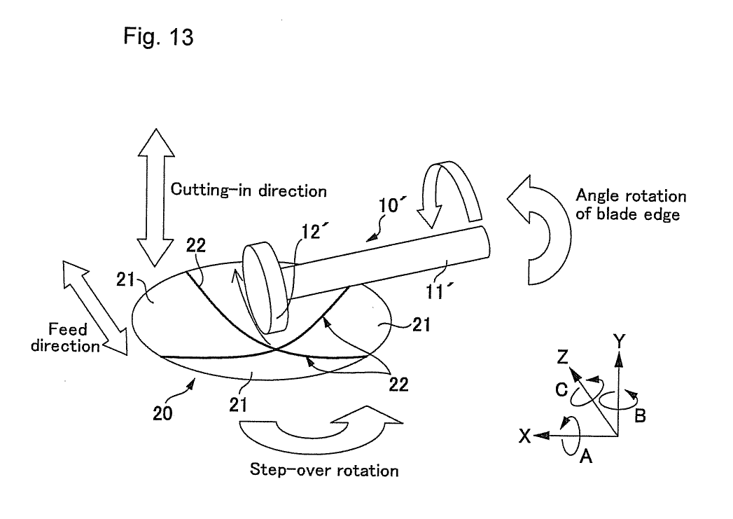

FIG. 14 An explanatory illustration of machining by a milling cutter.

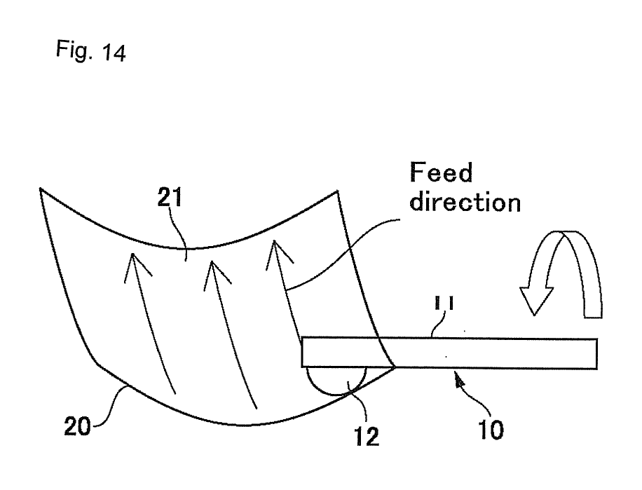

FIGS. 15a and 15b are explanatory illustrations showing a problem of a conventional machining method (a manufacturing method of an optical device).

### DESCRIPTION OF CODES

10 Milling cutter
10′ Grinding tool with shaft
11, 11′ Rotary shaft
12 Blade portion
12′ Grindstone (Blade portion)
20 Base material
21 Machining face
22 Boundary part

### DETAILED DESCRIPTION OF THE PREFERRED EMBODIMENTS

Embodiments of the present invention are described referring to the drawings.

### Embodiment 1

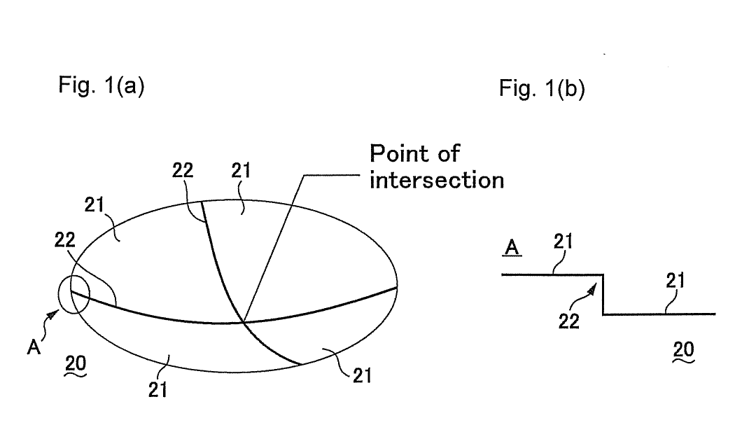

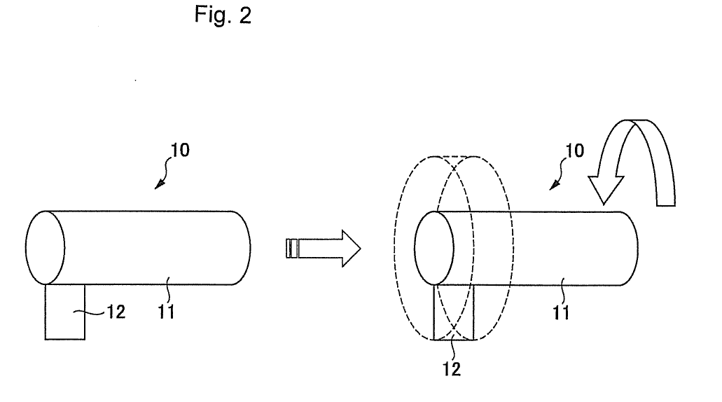

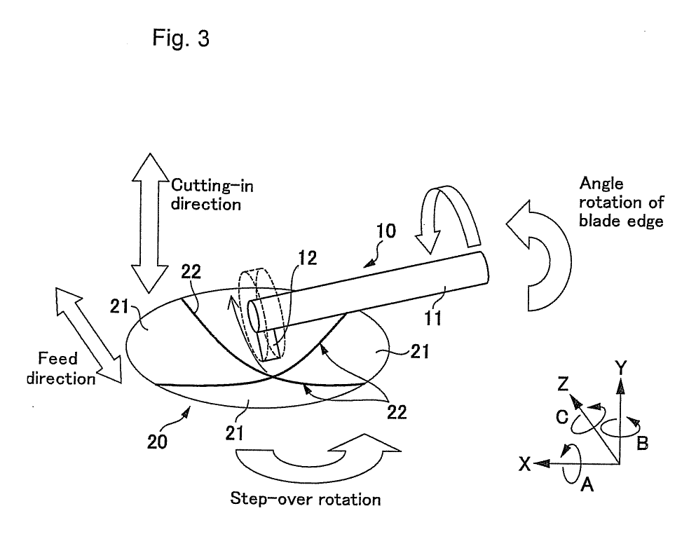

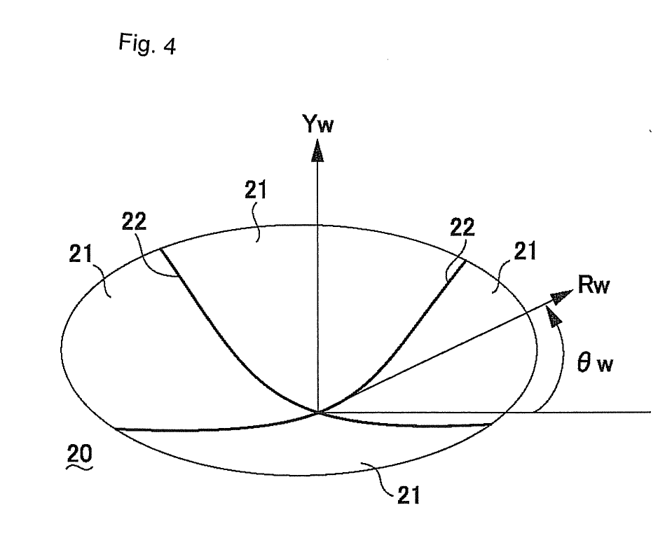

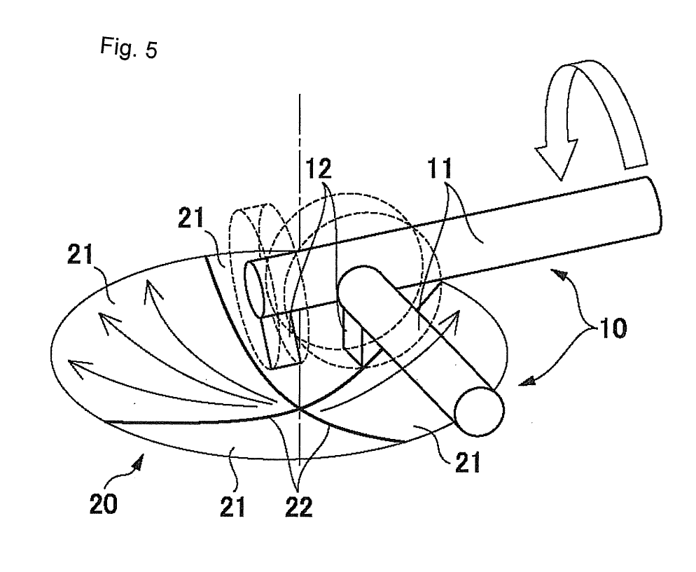

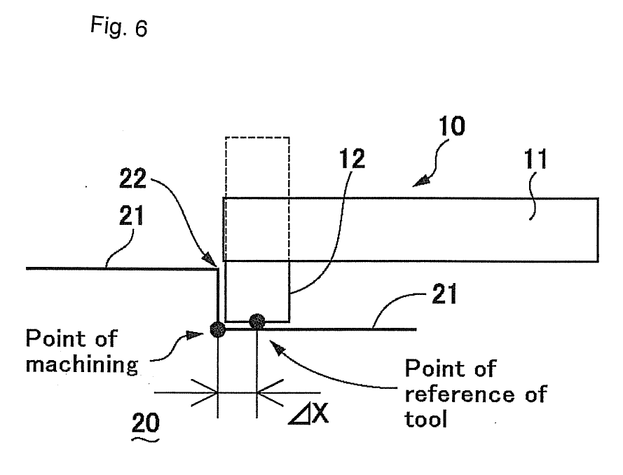

FIGS. 1 (a) and (b) are respectively an explanatory illustration of an optical device to which the present invention is applied, and a cross-sectional view of a step formed at a border area between machining faces (device faces) of the optical device. FIG. 2 is an explanatory illustration of a square milling cutter. FIG. 3 is an explanatory illustration showing the machining method (the manufacturing method of an optical device) of Embodiment 1 of the present invention. FIG. 4 is an explanatory illustration of the cylindrical polar coordinate system used in the machining method of this embodiment. FIG. 5 is an explanatory illustration of machining the boundary part in the machining method of this embodiment. FIG. 6 is a cross-sectional view of the machining by the method shown in FIG. 5.

This embodiment explains an example of manufacturing an optical device (lens) that uses a milling cutter as a tool using its outside circumference for cutting, in which a blade portion projects from a rotary shaft to the side; the base material for the optical device is cut by the milling cutter to manufacture an optical device (lens) in which four machining faces 21 (device faces) are arranged in the circumferential direction within a circular concave surface and boundary parts 22 of the four machining faces 21 intersect at one point, as shown in FIG. 1 (a).

The four machining faces 21 (division lens faces/device faces) are respectively formed by different curved surfaces, and the boundary part 22 is formed as a step as shown in FIG. 1 (b).

In order to manufacture such an optical device, an optical material such as resin is cut in a lens shape by a milling cutter 10 (square milling cutter) shown in FIG. 2. In the milling cutter 10, the blade portion 12 projects from the rotary shaft in the direction orthogonal to the axial line of the rotary shaft 11. The milling cutter 10 [lit: 11] of this embodiment is a square milling cutter whose blade portion 12 is rectangular when the blade portion 12 is viewed from its rake face, and it traces a cylindrical face during high speed rotation.

A machining tool having such a milling cutter 10 is equipped with a three axis linear movement mechanism (feed mechanism) represented by arrows, X, Y and Z in FIG. 3 and a rotation mechanism represented by arrows, A, B and C. Hereinafter, the rotation around the X-axis, rotation around the Y-axis and the rotation around the Z-axis of the rotation mechanism, indicated by the arrows A, B, and C will be called A-axis, B-axis and C-axis. Note that, since machining of this embodiment is performed by relatively moving the milling cutter 10 and the base material 20, the feed mechanism indicated by the arrows, X, Y and Z, and the rotation mechanism indicated by the arrows A, B and C are respectively configured on either the milling cutter 10 or on the base material 20, whichever they are most suitable with.

The base material 20 is machined by such a machining tool in the following manner: first, while having the milling cutter 10 rotated about the axial line as indicated by the arrow, A, the cutter cuts in the base material 20 in the Y-axis (cutting-in direction); by feeding along the Z-axis (feed direction), the machining face 21 is cut; at that time, the movements along the Y-axis and Z-axis are simultaneously performed to form each division lens face having a predetermined curved surface.

In this embodiment, using the point of intersection of the boundary parts 22 as the origin, the feed direction is set in the radial direction on the base material to cut the base material 20; then, the angle position of the feed direction is changed in order.

In the machining programming for the machining tool of this embodiment, the coordinate system uses the cylindrical polar coordinate system (Rw, θw, Yw) in which the point of intersection of the boundary parts 22 is used as the origin and the center (optical axis) of the optical device is used as a reference axis, as shown in FIG. 4. Therefore, the point of machining is Yw corresponding to Rw under the condition where θw is constant.

Under this control, a one-time feed [of the tool] with respect to the machining face 21 is completed; then, the milling cutter 10 is relieved from the base material 20 by the Y-axis movement, and a step-over by the B-axis rotation is performed; the above cutting operation is repeated.

The B-axis rotation pitch, Bp “rad” is defined by the following formula:

Bp<(Hmax)/((rmax)*Tan(φmax) formula (a)

where Hmax is the maximum tolerable limit of surface roughness, rmax is the maximum radius from the point of intersection and φmax (>0) is the maximum angle of inclination in the θw direction.

In this machining method, for cutting the machining face 21, the rotary shaft 11 is directed in the direction intersecting with the boundary part 22; for cutting the vicinity of the boundary part 22, the rotary shaft 11 is directed in the direction orthogonal to the boundary part 22, and the Z-axis (feed direction) is parallel to the boundary part 22, as shown in FIG. 5. With this setting, the lower machining face 21 of two adjacent machining faces 21 is cut. At that time, as shown in FIG. 6, the coordinate of the B-axis angle of the coordinate of the X-axis position, at which the internal corner of the step and the corner of the milling cutter 10 are coincided with each other, is set in such way that the step and the milling cutter 10 do not interfere with each other, i.e., the area for forming the step will not be cut.

Thus, in this embodiment, for machining the machining face 21, the milling cutter 10 and the base material 20 are relatively moved in the cutting-in direction and the feed direction to cut the base material; however, for machining the boundary part 22, the rotary shaft 11 is directed in the direction orthogonal to the boundary part 22 and the Z-axis (feed direction) is set parallel to the boundary part 22 to cut the lower machining face 21 of the two adjacent machining faces 21. Therefore, the shape of the boundary part 22 becomes the same as that of the blade portion 12, thus being controlled with high precision. Thus, the step can be shaped such that the side face wall stands upright. In an optical device, a step can be formed in such a sharp shape that the corner thereof is not blunt but the step face stands upright; therefore, the width of the boundary part 22 is narrow. For this reason, light incident on the boundary part 22 is prevented from being lost or going astray.

In this embodiment, the feed direction is set in the radial direction on the base material 20 using the point of intersection of the boundary parts 22 as a center to cut the base material 20; therefore, the center area of the optical device is cut many times, making a surface having little surface roughness (smooth surface). The vicinity of the point of intersection of the boundary part 22 is the center of the optical axis of the optical device, and surface accuracy of this area is high, thus manufacturing an optical device with high optical property.

### Embodiment 2

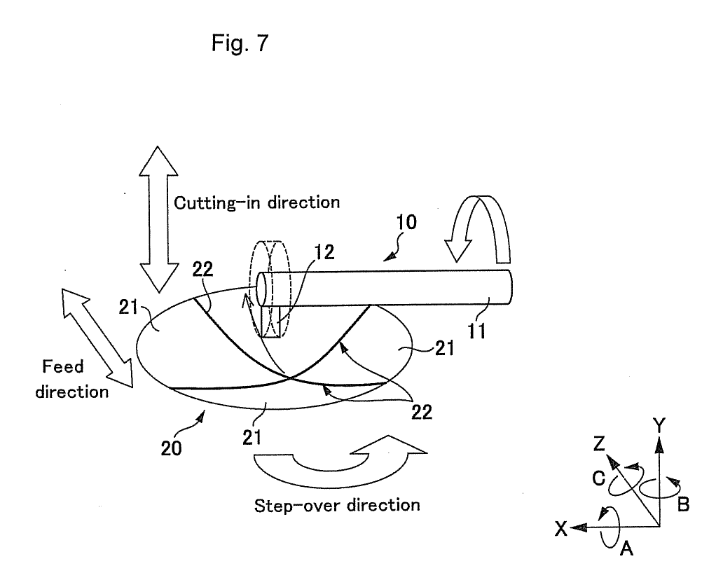

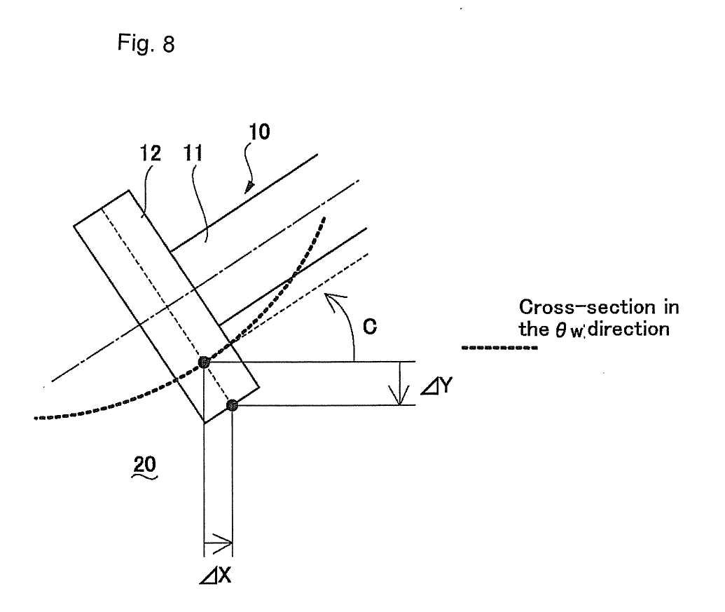

FIG. 7 is an explanatory illustration showing a machining method (a manufacturing method of an optical device) of Embodiment 2 of the present invention. FIG. 8 is an explanatory illustration showing the machining method of this embodiment in which the rotary shaft 11 is tilted.

In the method of Embodiment 1, when the angle of inclination, φmax, in the θw direction becomes large, surface roughness, Hmax, tends to become large as well. In this case, a method described hereinafter referring to FIG. 7 may be adopted. Note that, even in this embodiment, the milling cutter 10 shown in FIG. 2 is used in the same manner as Embodiment 1. Also, even in this embodiment, a three axis linear movement mechanism (feed mechanism) represented by the arrows, X, Y and Z is provided, and the rotation mechanism represented by the arrows, A, B and C is provided.

In this embodiment, as the milling cutter 10 is selected one having the width of the blade edge, L, which satisfies the following condition:

L<2*√(2*(Hmax)*(ρ min)−(Hmax)²) formula (b)

where Hmax is the maximum tolerable limit of surface roughness, and ρ min (>0) is the minimum radius of curvature of the section curve in the θw direction. Even in this embodiment, the point of intersection of the boundary parts 22 is used as the original point, the feed direction is set in the radial direction on the base material 20, and then the base material 20 is cut; then, the angle position of the feed direction is changed in order in the same manner as in Embodiment 1. Further, as shown in FIG. 7, the base material 20 and the milling cutter 10 are arranged such that the X-axis is inclined.

The cutting-in by the Y-axis movement is performed as well as the feed by the Z-axis movement. At that time, the X-axis, Y-axis, Z-axis and C-axis are simultaneously moved to form the machining face 21 of a curved surface.

As shown in FIG. 8, the C-axis is rotated while coincided with the angle of inclination of the machining shape in the θw direction. The X-axis is used for compensating the displacement, ΔX, of the blade edge caused by the C-axis rotation. Also, the Y-axis is used for compensating the displacement, ΔY, of the blade edge caused by the C-axis rotation.

After the machining face 21 is formed in the above manner, the milling cutter 10 is relieved from the base material 20 by the Y-axis movement, and then a step over by the B-axis rotation is performed.

Near the boundary part 22, the rotary shaft 11 is directed in the direction orthogonal to the boundary part 22 and the Z-axis (feed direction) is set parallel to the boundary part 22 to cut the lower machining face 21 of two adjacent machining faces 21.

The above operations are repeated to form the four machining faces 21 arranged in the radial direction and the four boundary parts (steps) extending in the radial direction.

Even in this embodiment, for machining the boundary part 22, the rotary shaft 11 is directed in the direction orthogonal to the boundary part 22 and the X-axis (feed direction) is set parallel to the boundary part 22 to cut the lower machining face 21 of two adjacent machining faces 21 in the same manner as in Embodiment 1. Therefore, the shape of the boundary part 22 becomes the same as that of the blade portion 12, thus being controlled with high precision. Thus, the step can be shaped such that the side face wall stands upright.

According to this embodiment, there is not much relation between the B-axis rotation pitch and surface roughness, and surface roughness is expressed by the aforementioned formula (b). Note that the B-axis rotation pitch takes the value with which the blade width, L, can be utilized in a maximum manner.

### Embodiment 3

When error in the shape near the boundary part 22 can be tolerated, as the cutting tool may be used a milling cutter 10 whose blade portion 12 is circular (convex radius milling cutter) when the blade portion is viewed from its rake face (feed direction). The milling cutter 10 has an arc edge and traces a solid torus during high speed rotation. Even when such a convex radius milling cutter 10 is used, the milling cutter 10 and the base material 20 are arranged as shown in FIG. 3.

As the milling cutter 10 may be used the one having the radius of curvature of the cutting blade, Rc, that satisfies the following formula:

Rc<((dmax)²+(tmax)²)/(2*(tmax)) formula (c)

where dmax is the maximum tolerable limit of the width of the error (roundness of internal edge) of the boundary part 22 and tmax is the maximum value of the step.

In order to perform machining on the base material 20 with such a machining tool, while having the milling cutter 10 rotated as indicated by the arrow A, the tool cuts in the base material with the movement along the Y-axis (in the cut-in direction). Also, the tool keeps cutting the machining face 21 with the feed by the movement along the Z-axis (in the feed direction). At that time, the Y-axis and Z-axis are simultaneously moved to form each division lens surface having a predetermined curved surface.

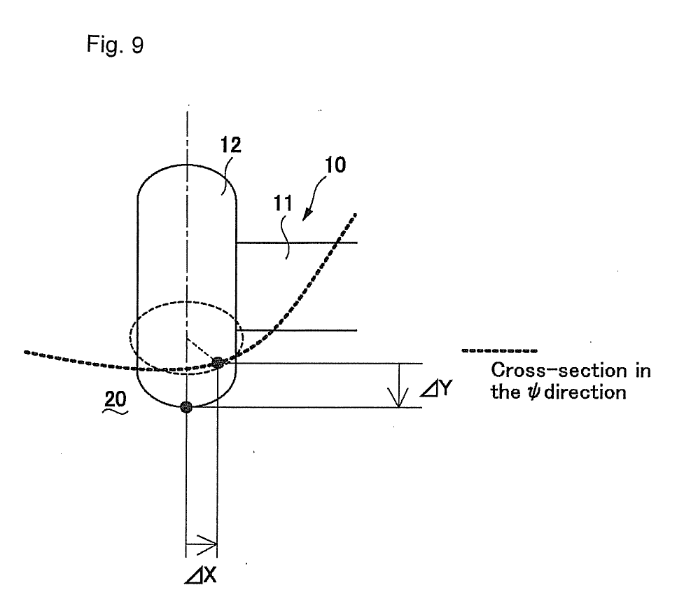

Also, the coordinates (X, Y, Z) of the point of reference of the tool in the workpiece coordinate system is determined such that normal of the point of machining coincides with normal of a point on the solid torus which the milling cutter 10 traces, as shown in FIG. 9. At that time, the X-axis is used for compensating the displacement, ΔX, of the blade edge caused by the aforementioned reason. Also, the Y-axis is used for compensating the displacement, ΔY of the blade edge.

After forming the machining face 21 in the above manner, the milling cutter 10 is relieved from the base material 20 by the Y-axis movement, and then a step over by the B-axis rotation is performed. When the machining face 21 is spherical, the B-axis rotation pitch, Bp [Bp(rad)] is defined in the following formula:

Bp<(2/(rmax))*√(2*(Hmax)/(1/(ρ−Rc)+1/Rc)) formula (d)

where Hmax is the maximum tolerable limit of surface roughness, rmax is the maximum radius from the point of intersection, Rc is the radius of curvature of the cutting edge of the milling cutter 10, ρ is the radius of spherical surface and Bp is the B-axis rotation pitch.

Even in this embodiment, near the boundary part 22, the rotary shaft 11 is directed in the direction orthogonal to the boundary part 22 and the Z-axis (feed direction) is set parallel to the boundary part 22 to cut the lower machining face 21 of two adjacent machining faces 21, in the same manner as in Embodiments 1 and 2.

The above operations are repeated to form the four machining faces 21 arranged in the radial direction and the four boundary parts (steps) extending in the radial direction.

Even in this embodiment, for machining the boundary part 22, the rotary shaft 11 is directed in the direction orthogonal to the boundary part 22 and the Z-axis (feed direction) is set parallel to the boundary part 22 to cut the lower machining face 21 of the two adjacent machining faces 21 in the same manner as in Embodiment 1. Therefore, the shape of the boundary part 22 becomes identical as that of the blade portion 12, being controlled with high precision. Thus, [the boundary part] can be formed to have the width with which the arc shape [of the tool] left at the step can be ignored. Therefore, when it is an optical device, light incident on the boundary part 22 can be prevented from being lost or going astray.

Also, in this embodiment, the C-axis rotation is not necessary, and a surface with better surface roughness than that of Embodiment 1 can be obtained.

### Embodiment 4

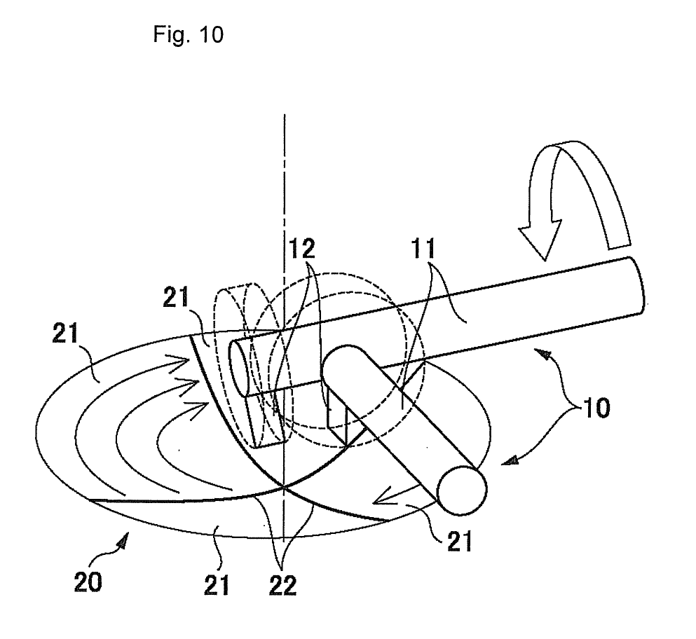

FIG. 10 is an explanatory illustration showing a machining method (a manufacturing method of an optical device) of Embodiment 4 of the present invention.

When Embodiment 1 is modified in the following manner, cutting can be performed in the direction of the arc-shape which has the point of intersection of the boundary parts 22 as a center, as shown in FIG. 10. In other words, the blade portion 12 of the milling cutter 10 at an initial point is coincided with the boundary part 22 by the B-axis rotation. When starting the cutting machining with a lower face of the machining faces 21 at the step, the rotary shaft 11 is directed in the direction orthogonal to the boundary part 22, and the coordinate of the B-axis angle or of the X-axis position is determined such that the [internal] corner of the step and the corner portion of the blade portion 12 of the milling cutter 10 are coincided with each other.

Next, the cutting-in is performed with the Y-axis movement and also the feed is performed with the B-axis rotation. Consequently, since the feed direction is set to trace the arc shape which uses a given position on the base material 20 as a center, the tool mark will be in an arc shape. At that time, by moving the Y-axis and the Z-axis simultaneously, the machining face 21 is machined to be a curved surface. Note that, even in this embodiment, as the coordinate system, the cylindrical polar coordinate system (Rw, θw, Yw) is considered in which the point of intersection of the boundary parts 22 is used as the origin and the center position of the optical device is used as a reference axis. Therefore, Yw corresponding to θw under the condition where Rw is constant is considered as the point of machining.

Next, the blade portion 12 of the milling cutter 10 is coincided with the boundary part 22 at the end point by the B-axis rotation. When the continuous surface shape ends with a lower side of the step, the coordinate of the B-axis angle the coordinate of the X-axis position, at which the [internal] corner of the step and the corner of the milling cutter are coincided with each other, is determined.

After machining of one of the machining faces 21 is completed, the milling cutter 10 is relieved from the base material 20 by the Y-axis movement, and then a step-over by the B-axis rotation is performed; the aforementioned cutting operation is repeated.

Even in this embodiment, for machining the machining face 21, the milling cutter 10 and the base material 20 are relatively moved to cut the base material 20; for forming the boundary part 22, the rotary shaft 11 of the milling cutter 10 is directed in the direction orthogonal to the boundary part 22. For this reason, the shape of the boundary part 22 can be controlled by the shape of the blade portion 12 with high precision, and the step can be shaped such that the side face wall stands nearly upright. Therefore, when it is used in an optical device, a step can be formed in such a sharp shape that the corner thereof is not blunt but the step face is nearly upright; thus, light that has entered the boundary part 22 can be prevented from being lost or going astray.

### [Other Machining Method]

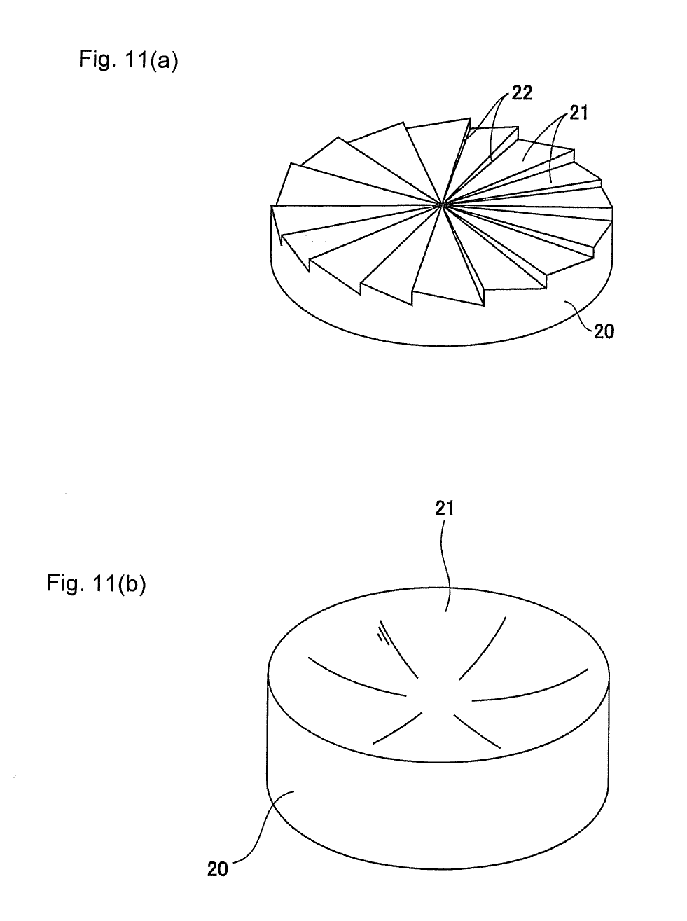

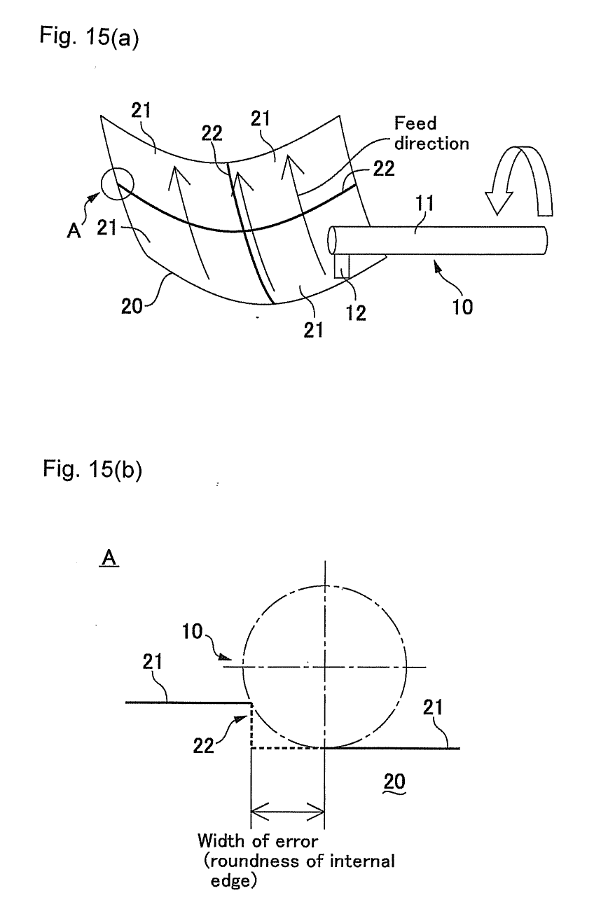

Note that the above embodiments have explained the example of manufacturing an optical device (lens), as shown in FIG. 1 (a), in which the four machining faces 21 (device faces) are arranged in the circumferential direction within a circular concave surface, and the boundary parts 22 of the four machining faces 21 intersect at one point; however, the present invention may be applied to manufacturing an optical device (transmitting refractive deflector), as shown in FIG. 11 (a), in which flat machining faces 21 (device faces) are arranged in multiple in the circumferential direction on one side of a circular plate, and the boundary parts 22 of the multiple machining faces 21 intersect at one point. Also, steps are provided as in FIG. 11 (a); however, the steps which create the boundary parts may be eliminated to make a continuous curved surface. Further, as shown in FIG. 11 (b), the present invention may be applied to machining the machining face 21 to be a spherical surface. Also, it can be applied to an optical device (lens) in the shape described referring to FIG. 15.

The above embodiments have used the example of cutting an optical material such as resin in a lens shape with the milling cutter 10; however, the present invention may be applied to manufacturing a mold for molding an optical device by cutting a metallic material for a mold with the milling cutter 10.

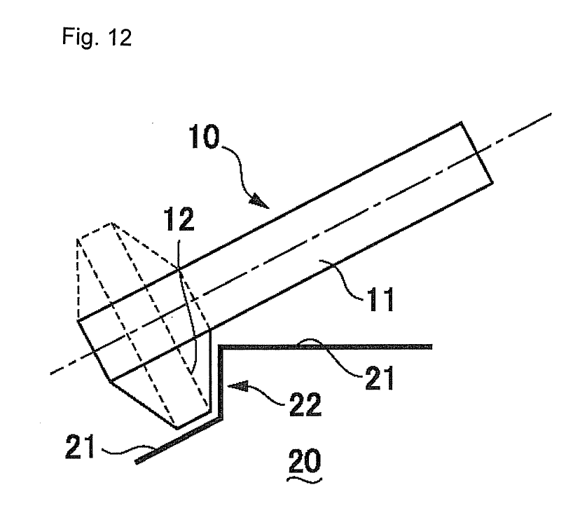

In the above embodiments, as the milling cutter 10, the one having a rectangular blade portion 12 is used; however, a milling cutter 10 having a trapezoidal blade portion 12 as shown in FIG. 12 may be used depending on the required step shape. Also, a concave radius milling cutter may be used as the milling cutter, in which the shape of the blade portion thereof is circular when the blade portion is viewed from its rake face (a primary face [of the tool] for the cutting operation).

Furthermore, the present invention may be applied to a grinding machining that uses a grindstone with shaft 10′, in place of the milling cutter 10, in which a disc-like or cylindrical grindstone 12′ projects as a blade portion from the rotary shaft 11′. The grindstone with shaft 10′ has the grindstone 12′ with a sharp cornered edge portion; however, a grindstone in which the edge portion of the grindstone 12′ is in an arc shape may be used as well. In the same manner as the machining using the milling cutter 10, even when such a grindstone with shaft 10′ is used, it is preferred that the grindstone with shaft 10′ and the base material 20 be relatively moved in the cutting-in direction and the feed direction to form a machining face 21; for forming a step to the boundary part 22 between adjacent machining faces 21, the rotary shaft 11′ be directed in the direction orthogonal to the boundary part 22 to grind the lower machining face 21 of the two adjacent machining faces 21.

When a square milling cutter having a rectangular blade edge or a grinding tool having the same shape is used, the smaller the width of the blade edge is, the less light loss will be; when a convex radius milling cutter having a circular blade edge or a grinding tool having the same shape is used, the smaller the blade edge, R, is, the less light loss will be. The width of the blade edge of the tool having a rectangular blade edge is preferably 20 μm or less, and more preferably 10 μm or less. When the tool having a circular edge is used, the edge, R, is preferably 0.2 mm or less, and even more preferably 0.1 mm or less.

Although not illustrated, as another tool beside the above-mentioned tools may be used a grindstone with shaft that has a rotary shaft and a grindstone projecting from the end face of the rotary shaft. In this case, it is preferred that, while having the grindstone with shaft rotated about the axial line of the rotary shaft, the grindstone with shaft and the base material are relatively moved in the cutting-in direction and the feed direction to form a machining face; for forming a step at the boundary part between adjacent machining faces, the rotary shaft be raised to grind the lower machining face of the two adjacent machining faces. Also, a wheel-type grindstone that is attached to a rotary disk can be used as the tool. In this case, it is preferred that, while having the grindstone rotated with the rotary disk, the grindstone and the base material be relatively moved in the cutting-in direction and the feed direction to form a machining face; and for forming a step at the boundary part between adjacent machining faces, the main spindle of the rotary disk is directed in the direction orthogonal to the boundary part to grind the lower machining face of the two adjacent machining faces.

Further, although not illustrated, the present invention can be applied to machining using an end mill such as a single-blade end mill, in place of the milling cutter 10 or the grindstone with shaft 10′. As the end mill, a square end mill whose blade portion is rectangular or a ball end mill whose blade portion is circular when the blade portion is viewed from its rake face can be used. Also, in machining using the end mill, it is preferred that, while having the end mill rotated about the axial line of the rotary shaft, the end mill and the base material are relatively moved in the cutting-in direction and the feed direction to form a machining face; for forming a step at the boundary part between adjacent machining faces, it is preferred that the rotary shaft be raised to cut the lower machining face of the two adjacent machining faces.

Also, the present invention can be applied to machining that uses a cutting tool. As a cutting tool can be used a square cutting tool whose blade portion is rectangular or a concave radius cutting tool whose blade portion is circular when the blade portion is viewed from the rake front. Even in machining using the cutting tool, it is preferred that the cutting tool be relatively moved with respect to the base material in the cutting-in direction and the feed direction to form a machining face, and for forming a step at the boundary part between adjacent machining faces, the cutting tool be raised at the boundary part to cut the lower machining face of the two adjacent machining faces.

What is claimed is:

1. A method for manufacturing an optical device comprising:
forming a machining face in a predetermined shape by cutting, grinding or polishing a base material for manufacturing an optical device with a tool, and
controlling the relative position between said tool and said base material by the conditions represented by the cylindrical polar coordinate system.

2. The method for manufacturing an optical device as set forth in claim 1, wherein said machining face is arranged in multiple in the circumferential direction and the feed direction is set in the radial direction from a given position on said base material when manufacturing said multiple machining faces.

3. The method for manufacturing an optical device as set forth in claim 1, wherein said machining face is arranged in multiple in the circumferential direction and the feed direction is set to trace an arc shape having a center on a given position on said base material when manufacturing said multiple machining faces.

4. The method for manufacturing an optical device as set forth in claim 1, wherein the relative position between said tool and said base material is continuously changed in a cutting-in direction to machine said machining face to be a curved surface.

5. The method for manufacturing an optical device as set forth in claim 1, wherein said tool is a milling cutter, end mill, cutting tool or grindstone.

6. The method for manufacturing an optical device as set forth in claim 1, wherein said tool is a square milling cutter, square end mill or square cutting tool, in which the shape of the blade portion is rectangular when said blade portion is viewed from its rake face, or a grindstone in which the edge portion of the stone is angular.

7. The method for manufacturing an optical device as set forth in claim 1, wherein said tool is a convex radius milling cutter, ball end mill or convex radius cutting tool, in which the shape of the blade portion is circular when said blade portion is viewed from its rake face, or a grindstone in which the edge portion of the stone is in an arc shape.

8. The method for manufacturing an optical device as set forth in claim 1, wherein said tool is a milling cutter equipped with a rotary shaft and a blade portion projecting in the direction intersecting with the axial line direction of said rotary shaft; while having said milling cutter rotated about the axial line of said rotary shaft, said milling cutter and said base material are relatively moved in the cutting-in direction and the feed direction to form said machining face; when forming a step at the boundary part between adjacent machining faces, said rotary shaft of said milling cutter is directed in the direction orthogonal to said boundary part to cut the lower machining face of two adjacent machining faces.

9. The method for manufacturing an optical device as set forth in claim 1, wherein said tool is a single-blade end mill equipped with a rotary shaft and a blade portion projecting from an end face of said rotary shaft; while having said end mill rotated about the axial line of said rotary shaft, said end mill and said base material are relatively moved in the cutting-in direction and the feed direction to form said machining face; when forming a step at the boundary part between adjacent machining faces, said rotary shaft is raised to cut the lower machining face of two adjacent machining faces.

10. The method for manufacturing an optical device as set forth in claim 1, wherein said tool is a grindstone with shaft equipped with a rotary shaft and a grindstone projecting in the direction intersecting with the axial line of said rotary shaft; while having said grindstone rotated about the axial line of said rotary shaft, said grindstone and said base material are relatively moved in the cutting-in direction and the feed direction to form said machining face; when forming a step at the boundary part between adjacent machining faces, said rotary shaft is directed in the direction orthogonal to said boundary part to grind the lower machining face of two adjacent machining faces.

11. The method for manufacturing an optical device as set forth in claim 1, wherein said tool is a grindstone with shaft equipped with a rotary shaft and a grindstone projecting from an end face of said rotary shaft; while having said grindstone rotated about the axial line of said rotary shaft, said grindstone with shaft and said base material are relatively moved in the cutting-in direction and the feed direction to form said machining face; when forming a step at the boundary part between adjacent machining faces, said rotary shaft is raised to grind the lower machining face of two adjacent machining faces.

12. The method for manufacturing an optical device as set forth in claim 1, wherein said tool is a wheel-type grindstone that is to be attached to a rotary disk; while having said grindstone rotated with said rotary disk, said grindstone and said base material are relatively moved in the cutting-in direction and the feed direction to form said machining face; when forming a step at the boundary part between adjacent machining faces, a main spindle of said rotary disk is directed in the direction orthogonal to said boundary part to grind the lower machining face of two adjacent machining faces.

13. The method for manufacturing an optical device as set forth in claim 1, wherein said tool is a cutting tool; said cutting tool is relatively moved with respect to said base material in the cutting-in direction and the feed direction to form said machining face; when forming a step at the boundary part between adjacent machining faces, said cutting tool is raised to cut the lower machining face of two adjacent machining faces.

14. The method for manufacturing an optical device as set forth in claim 1, wherein said base material is an optical material that constitutes said optical device.

15. The method for manufacturing an optical device as set forth in claim 1, wherein said base material is a mold material for molding said optical device.

16. An optical device manufactured by using the method defined in claim 1.

17. A method for manufacturing an optical device in which a step is formed at the boundary part between adjacent device faces, wherein, while having a tool equipped with a rotary shaft and a blade portion projecting from said rotary shaft toward the side rotated about the axial line of said rotary shaft, said tool and a base material for forming an optical device are relatively moved in the cutting-in direction and the feed direction to form a machining face which constitutes said device face; at said boundary part, said rotary shaft is directed in the direction orthogonal to said boundary part to cut the lower machining face of two adjacent machining faces.

18. The method for manufacturing an optical device as set forth in claim 17, wherein said tool is a milling cutter.

19. The method for manufacturing an optical device as set forth in claim 18, wherein said milling cutter is a square milling cutter of which the blade edge is rectangular when said blade portion is viewed in the feed direction.

20. The method for manufacturing an optical device as set forth in claim 18, wherein said milling cutter is a convex radius milling cutter of which the blade edge is circular when said blade portion is viewed in the feed direction.

21. The method for manufacturing an optical device as set forth in claim 17, wherein said tool is a grinding tool in which a disk-like or cylindrical grindstone projects from said rotary shaft as said blade portion.

22. The method for manufacturing an optical device as set forth in claim 17, wherein the relative position between said tool and said base material is continuously changed in said cutting-in direction to machine said machining face to be a curved surface.

23. The method for manufacturing an optical device as set forth in claim 17, wherein said machining face is arranged in multiple in the circumferential direction; when forming said multiple machining faces, said feed direction is set in the radial direction from a given position on said base material.

24. The method for manufacturing an optical device as set forth in claim 17, wherein said machining face is arranged in multiple in the circumferential direction; when forming said multiple machining faces, said feed direction is set to trace an arc shape having a given position on said base material as a center.

25. The method for manufacturing an optical device as set forth in claim 23, wherein machining by said tool is controlled by the conditions represented by the cylindrical polar coordinate system.

26. The method for manufacturing an optical device as set forth in claim 17, wherein said base material is an optical material that constitutes said optical device.

27. The method for manufacturing an optical device as set forth in claim 17, wherein said base material is a mold material for molding said optical device.

28. An optical device manufactured by using the method defined in claim 17.
